(19) United States
(12) Patent Application Publication
(10) Pub. No.: US 2015/0132855 A1
(43) Pub. Date: May 14, 2015

(54) INTERFACE FOR DISPOSABLE SENSORS

(71) Applicant: QUALCOMM Incorporated, San Diego, CA (US)

(72) Inventors: Russel Allyn Martin, Menlo Park, CA (US); Ana Rangelova Londergan, Santa Clara, CA (US); Justin Phelps Black, Santa Clara, CA (US); Rihui He, Fremont, CA (US); Igor Tchertkov, San Jose, CA (US); Raghu Subramanian Srivatsa, Santa Clara, CA (US)

(73) Assignee: QUALCOMM Incorporated, San Diego, CA (US)

(21) Appl. No.: 14/076,844

(22) Filed: Nov. 11, 2013

(51) Int. Cl. G01N 21/78

(52) U.S. Cl. CPC G01N 21/78
USPC 436/20; 436/164; 422/82.05; 436/95

(57) ABSTRACT

Techniques described herein enable a mobile multifunction device to detect a disposable sensor card at an interface coupled to the mobile multifunction device, wherein the disposable sensor card is mounted inside an opening in the mobile multifunction device, detect analog information associated with the disposable sensor card, and convert analog information to digital information. Detecting analog information comprises detecting a non-transient change in at least a portion of the disposable sensor card, wherein at least a portion of the first disposable sensor card changes form in response to exposure to one or more stimuli from an environment of the first disposable sensor card. A non-transient change may include one or more of changing color, changing shape, changing chemical composition or changing electrical characteristics. Furthermore, the interface may be configured to receive disposable sensor cards with varying sensing capabilities. Each disposable sensor card may have one or more disposable sensors.

### BACKGROUND

1. Technical Field

Aspects of the disclosure relate to computing technologies. In particular, aspects of the disclosure relate to mobile device technologies, such as systems, methods, apparatuses, and computer-readable media for using disposable sensors.

2. Relevant Background

With increasing prevalence of mobile multifunction devices in every day operations, current generation of applications executing on mobile multifunction devices heavily rely on a large variety of sensors for providing contextual information to applications. However, the sensors integrated in these mobile multifunction devices are usually expensive sensor technologies that are usually integrated inside the mobile multifunction device and survive the life of the device, or at least for several years. The current sensors used in mobile multifunction devices exclude a wide range of sensors with transduction mechanisms that are either single use or have a relatively short life span with respect to the life of the mobile multifunction device.

### SUMMARY

According to one or more aspects of the disclosure, techniques described herein enable a mobile multifunction device to detect a disposable sensor card at an interface coupled to the mobile multifunction device, wherein the disposable sensor card is mounted inside an opening in the mobile multifunction device, detect analog information associated with the disposable sensor card, and convert analog information to digital information. Detecting analog information comprises detecting a non-transient change in at least a portion of the disposable sensor card, wherein the non-transient change to at least a portion of the first disposable sensor card is in response to exposure to one or more stimuli from an environment of the disposable sensor card. Non-transient change may include, but is not limited to, one or more of changing color, changing shape, changing chemical composition or changing electrical characteristics. Furthermore, the interface may be configured to receive multiple types of disposable sensor cards with varying sensing capabilities. Each disposable sensor card may have one or more disposable sensors.

An example mobile multifunction device may include an opening in the mobile multifunction device for receiving a first disposable sensor card, wherein the first disposable sensor card comprises a first disposable sensor and an interface coupled to the opening may be configured to detect analog information associated with at least a portion of the first disposable sensor card, and convert the analog information to digital information. The first disposable sensor card may be removable. In some instances, the first disposable sensor is depleted after one or a limited number of uses. The mobile multifunction device may be configured to receive the first disposable sensor card and a second disposable sensor card one at a time, wherein the first disposable sensor card has different sensing characteristics then the second disposable sensor card.

In one implementation, the first disposable sensor card may include the first disposable sensor and a second disposable sensor, wherein the first disposable sensor and the second disposable sensor have different sensing characteristics. The interface at the example mobile multifunction device may be further configured to detect a first identifier associated with the first disposable sensor card, and a processor coupled to the interface at the mobile multifunction device may be configured to process the digital information based on the detected first identifier.

In one implementation of the example mobile multifunction device, detecting analog information may include detecting a non-transient change in the first disposable sensor card, wherein at least a portion of the first disposable sensor card changes the form in response to exposure to one or more stimuli from an environment of the first disposable sensor card. Non-transient change may include one or more of changing color, changing shape, changing chemical composition or changing electrical characteristics. The first disposable sensor may be one or more of a pressure sensor, a humidity sensor, a temperature sensor, a radiation sensor, a light sensor, or a chemical sensor.

In one implementation of the example mobile multifunction device, converting the analog information to the digital information may include detecting a color associated with the first disposable sensor and converting the color information to the digital information for further processing by a processor. In one aspect, the sensing material of the first disposable sensor is followed by an at least one optical filter in the light path between a light source and a photo detector, for detecting a color associated with the first disposable sensor. In one implementation, the first disposable sensor card may not have a digital processor or an analog to digital convertor on the first disposable sensor card.

An example method, according to embodiments described herein, may include detecting, at a mobile multifunction device, a first type of a disposable sensor card at an interface coupled to the mobile multifunction device, wherein the disposable sensor card is placed inside an opening in the mobile multifunction device, detecting, at the mobile multifunction device, analog information associated with the disposable sensor card, and converting, at the mobile multifunction device, analog information to digital information. The first disposable sensor card may be removable. In some instances, the first disposable sensor is depleted after one or a limited number of uses. The method may be configured to receive the first disposable sensor card and a second disposable sensor card one at a time, wherein the first disposable sensor card has different sensing characteristics then the second disposable sensor card.

In one implementation, the first disposable sensor card may include the first disposable sensor and a second disposable sensor, wherein the first disposable sensor and the second disposable sensor have different sensing characteristics. The interface may be further configured to detect a first identifier associated with the first disposable sensor card, and a processor coupled to the interface at the mobile multifunction device may be configured to process the digital information based on the detected first identifier.

In one implementation of the method, detecting analog information may include detecting a non-transient change in at least a portion of the first disposable sensor card, wherein the non-transient change in at least a portion of the first disposable sensor card is in response to exposure to one or more stimuli from an environment of the first disposable sensor card. Non-transient change may include one or more of changing color, changing shape, changing chemical composition or changing electrical characteristics. The first disposable sensor may be one or more of a pressure sensor, a humidity sensor, a temperature sensor, a radiation sensor, a light sensor, or a chemical sensor.

In some implementations of the method, converting the analog information to the digital information may include detecting a color associated with the first disposable sensor and converting the color information to the digital information for further processing by a processor. In one aspect, the sensing material of the first disposable sensor is followed by an at least one optical filter in the light path between a light source and a photo detector, for detecting a color associated with the first disposable sensor. In one implementation, the first disposable sensor card may not have a digital processor or an analog to digital convertor on the first disposable sensor card.

An example non-transitory computer readable storage medium, wherein the non-transitory computer readable storage medium comprises instructions executable by a processor, the instructions may include instructions to detect a first type of a disposable sensor card at an interface coupled to a mobile multifunction device, wherein the disposable sensor card is placed inside an opening in the mobile multifunction device, detect analog information associated with the disposable sensor card, and convert analog information to digital information. The first disposable sensor card may be removable. In some instances, the first disposable sensor is depleted after one or a limited number of uses. The method may be configured to receive the first disposable sensor card and a second disposable sensor card one at a time, wherein the first disposable sensor card has different sensing characteristics then the second disposable sensor card.

In one implementation, the first disposable sensor card may include the first disposable sensor and a second disposable sensor, wherein the first disposable sensor and the second disposable sensor have different sensing characteristics. The non-transitory computer readable storage medium my include instructions to detect a first identifier associated with the first disposable sensor card, and a processor coupled to the interface at the mobile multifunction device may be include instructions to process the digital information based on the detected first identifier.

In one implementation of the method, detecting analog information may include instructions for detecting a non-transient change of the first disposable sensor card, wherein the non-transient change of at least a portion of the first disposable sensor card is in response to exposure to one or more stimuli from an environment of the first disposable sensor card. Non-transient change may include one or more of changing color, changing shape, changing chemical composition or changing electrical characteristics. The first disposable sensor may be one or more of a pressure sensor, a humidity sensor, a temperature sensor, a radiation sensor, a light sensor, or a chemical sensor.

In some implementations of the method, converting the analog information to the digital information may include instructions for detecting a color associated with the first disposable sensor and instructions for converting the color information to the digital information for further processing by a processor. In one aspect, the sensing material of the first disposable sensor is followed by an at least one optical filter in the light path between a light source and a photo detector, for detecting a color associated with the first disposable sensor. In one implementation, the first disposable sensor card may not have a digital processor or an analog to digital convertor on the first disposable sensor card.

An example apparatus may include means for detecting, at a mobile multifunction device, a first type of a disposable sensor card at an interface coupled to the mobile multifunction device, wherein the disposable sensor card is placed inside an opening in the mobile multifunction device, means for means for detecting, at the mobile multifunction device, analog information associated with the disposable sensor card, and means for converting, at the mobile multifunction device, analog information to digital information. The first disposable sensor card may be removable. In some instances, the first disposable sensor may be depleted after one or a limited number of uses. The apparatus may include means for receiving the first disposable sensor card and a second disposable sensor card one at a time, wherein the first disposable sensor card has different sensing characteristics then the second disposable sensor card.

In one implementation, the first disposable sensor card may include the first disposable sensor and a second disposable sensor, wherein the first disposable sensor and the second disposable sensor have different sensing characteristics. The interface may be further configured to include means for detecting a first identifier associated with the first disposable sensor card, and means to process the digital information based on the detected first identifier.

In one implementation of the example apparatus, detecting analog information may include means for detecting a non-transient change in the first disposable sensor card, wherein the non-transient change in at least a portion of the first disposable sensor card is in response to exposure to one or more stimuli from an environment of the first disposable sensor card. Non-transient change may include one or more of changing color, changing shape, changing chemical composition or changing electrical characteristics. The first disposable sensor may be one or more of a pressure sensor, a humidity sensor, a temperature sensor, a radiation sensor, a light sensor, or a chemical sensor.

In some implementations of the example apparatus, converting the analog information to the digital information may include means for detecting a color associated with the first disposable sensor and means for converting the color information to the digital information for further processing by a processor. In one aspect, the sensing material of the first disposable sensor is followed by an at least one optical filter in the light path between a light source and a photo detector, for detecting a color associated with the first disposable sensor. In one implementation, the first disposable sensor card may not have a digital processor or an analog to digital convertor on the first disposable sensor card.

The foregoing has outlined rather broadly features and technical advantages of examples in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

Aspects of the disclosure are illustrated by way of example. The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 illustrates a front view of an example mobile multifunction device that may implement one or more aspects of the disclosure.

FIG. 2 illustrates a side view of an example mobile multifunction device that may implement one or more aspects of the disclosure.

FIG. 3A and FIG. 3B illustrates example disposable sensor cards, according to aspects of the disclosure.

FIG. 4 depicts a block diagram, showing example components and/or modules for performing methods provided by embodiments of the invention.

FIG. 5 illustrates an example interface for implementing an optical module.

FIG. 6 is a flow diagram illustrating a method for performing embodiments of the invention according to one or more illustrative aspects of the disclosure.

FIG. 7 illustrates an example computing device incorporating parts of the device employed in practicing embodiments of the invention.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Prior to discussing embodiments of the invention, description of some terms may be helpful in understanding embodiments of the invention.

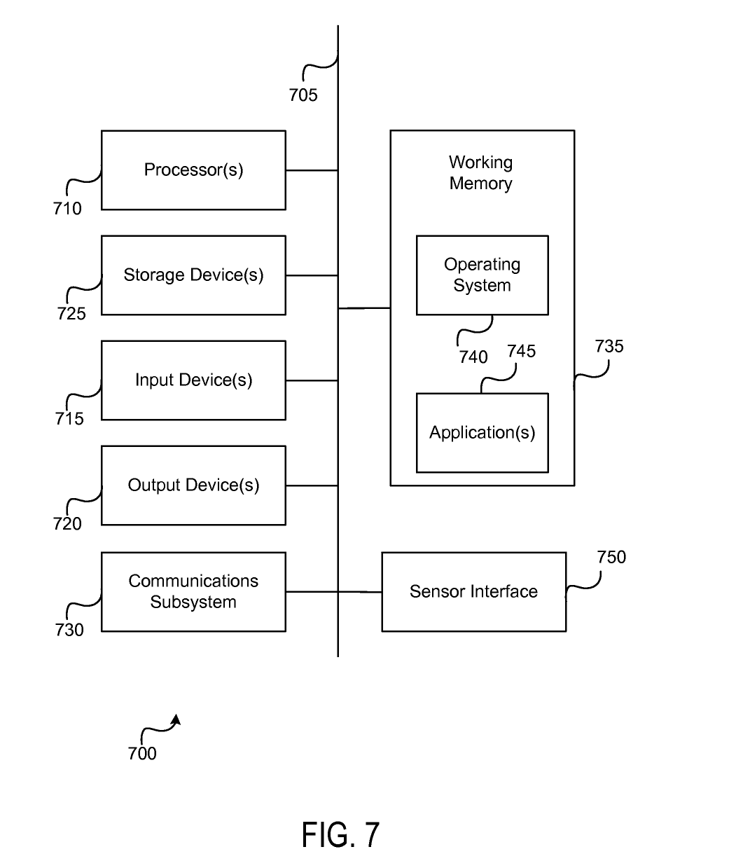

As discussed herein, a “mobile multifunction device” may comprise any electronic device that may be transported and operated by a user, which may provide an interface and sensing electronics to allow converting a physical property of a disposable sensor into information that may be read by the processing unit. The mobile multifunction device may be configured to receive analog information from a disposable sensor card and determine the stimulus from the environment. Examples of mobile multifunction devices include mobile phones (e.g. cellular phones), PDAs, tablet computers, net books, laptop computers, personal music players, hand-held specialized readers, etc. Besides other components discussed in FIG. 7, the mobile multifunction device comprises a processor unit and battery power.

As described herein, a disposable sensor may refer to a type of sensor that when exposed to stimulus from the environment results in a non-transient change to at least one portion of the sensor. In one embodiment, exposure to the stimulus may result in change in physical form of the sensor. Furthermore, as described herein, the disposable sensor is depleted after one or a limited number of uses or has a relatively short life span compared to integrated sensors on a mobile multifunction device. In one embodiment, a short life span may be considered to be less than a year whereas a mobile multifunction device may last for about 3 years under regular use conditions.

Stimulus may refer to factors in the environment of the mobile multifunction device causing a response by the disposable sensor. In one example, an analyte may be a stimulus to the disposable sensor, where the analyte is a substance or chemical constituent that is of interest for detecting by the mobile multifunction device.

A disposable sensor card may comprise one or more disposable sensors. The disposable sensor card may be easily mounted and unmounted from the mobile multifunction device without disassembling the mobile multifunction device. According to embodiments of the invention, in some implementations, analog to digital converters, processing logic and other expensive digital components are implemented as part of the mobile multifunction device and not the disposable sensor card. Therefore, the disposable sensor card can be cheaply manufactured, since it does not require these expensive components, such as an analog to digital converter, a processing unit, or even a power supply, in most implementations. Some implementations may however include inexpensive processing logic and power supply components, such as capacitors, that may be relatively inexpensive compared to a processing unit or a power supply. Furthermore, the disposable sensor card may be easily replaceable with a duplicate sensor card or a different sensor card at the opening on the mobile multifunction device.

Today, a wide variety of sensors are excluded from the mobile multifunction device ecosystem, such as toxic gas analyzers that may work on chemically treated paper tape and may be used for one or limited number of uses. Mobile multifunction devices do not support a wide variety of sensors since many of sensors have a very short life span, some limited to just a single use. Current mobile multifunction devices do not have a way of accommodating sensors with such a short life span. Additionally, many of these wide range of sensors are not applicable or useful to most mobile multifunction device users. Adding support for even a small subset of sensors from the wide range of sensors would require that the mobile multifunction device manufacturers provide support for select sensors by amortizing the cost of the select sensors to all users. Furthermore, the sensors can be very expensive, especially if they need to be replaced on a semi-regular bases.

Embodiments of the invention describe an interface on the mobile multifunction device that can facilitate receiving and processing of analog information received from the environment of the device for the purpose of detecting one or more different stimuli from the environment. The mobile multifunction device interface can be adapted to receive analog information from a variety of disposable sensor cards inserted in the mobile multifunctional device that may be adapted to detect different stimuli from the environment. The interface in the mobile multifunction device may be implemented as a slot or opening in the mobile multifunction device.

Providing analog to digital conversion and other digital processing and functionality on the mobile multifunction device may be advantageous in simplifying the design and reducing the costs of the disposable sensor card. Also, the analog to digital converter and other digital components associated with performing embodiments of the invention may not need to be replaced with the replacement of the disposable sensor card, since those components may not experience non-transient changes or change physical form in the process of measuring the detected environmental stimuli by the disposable sensor card. Additionally, the same analog to digital conversion components may be used to detect changes in different disposable sensor cards associated with different environmental stimuli. For example, the same analog to digital converter and other digital components of the mobile multifunction device may be configured to measure the composition of the air using a first disposable sensor card and pool chlorine using a second disposable sensor card.

Implementations of embodiments of the invention may provide several advantages such as constant and automatic monitoring of the environmental stimuli and monitoring of various different environmental stimuli at the same time using multiple sensing materials. For example, existing applications may allow visually reading a color change sensor for a disposable sensor at a particular point in time. Many color change sensors respond to chemical stimuli, such as pool chlorine test. However, if constant monitoring is needed then there is an advantage to automating the measurement and reporting or alarming the user automatically. An implementation of a toxic gas monitor using the mobile multifunction device is an example of such constant and automatic monitoring. Furthermore, if there is a single test point (i.e., one spot where the color changes), the change may be visually read. However, there are many chemicals or compositions that cannot be identified by a single sensing material and require multiple points of data because of cross response to other possible materials. For example, to measure the toxic nature of the air at a particular time, the composition of the air that may include several different chemicals may need to be detected and measured before alerting the user. Therefore, in such instances, an automated system that can measure several spots on the disposable sensor card continuously and use a method to identify the sampled material or materials would be advantageous.

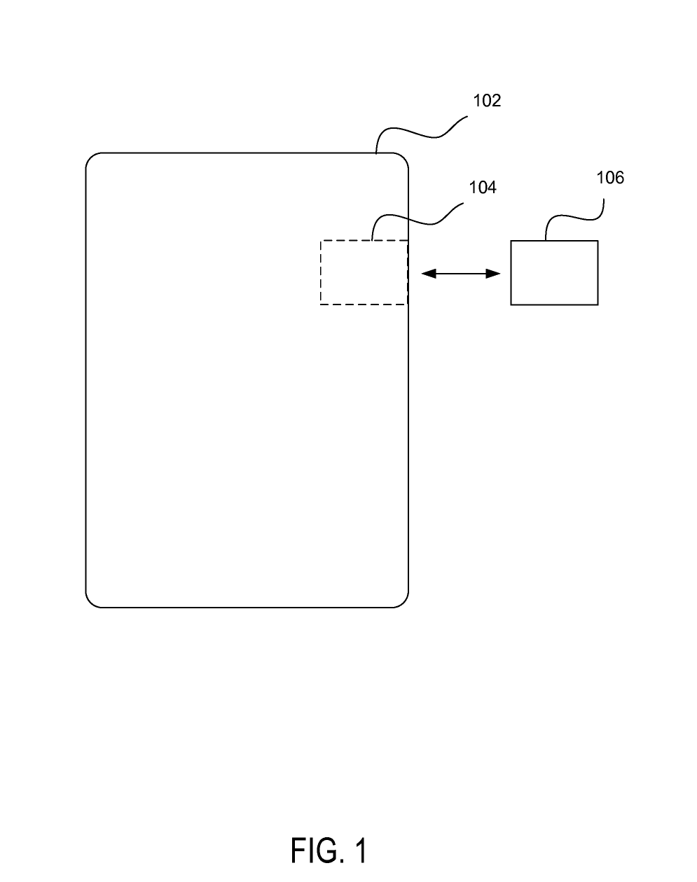

FIG. 1 illustrates an example mobile multifunction device 102 with an opening 104 for a disposable sensor card 106, according to one embodiment of the invention. An opening (or slot) to accept the disposable sensor card could be arranged in a manner similar to that of an add-on memory card, such as a micro-SD card, but with different connections to facilitate sensing of the environmental stimuli. FIG. 1 illustrates a non-limiting placement of the slot for receiving the disposable sensor card. In another implementation, it may be possible to share the same slot with a micro-SD or other cards. In yet another implementation, the mobile multifunction device 102 may interface with remote sensors using wireless or wired connection allowing for remote sensing and low cost peripherals.

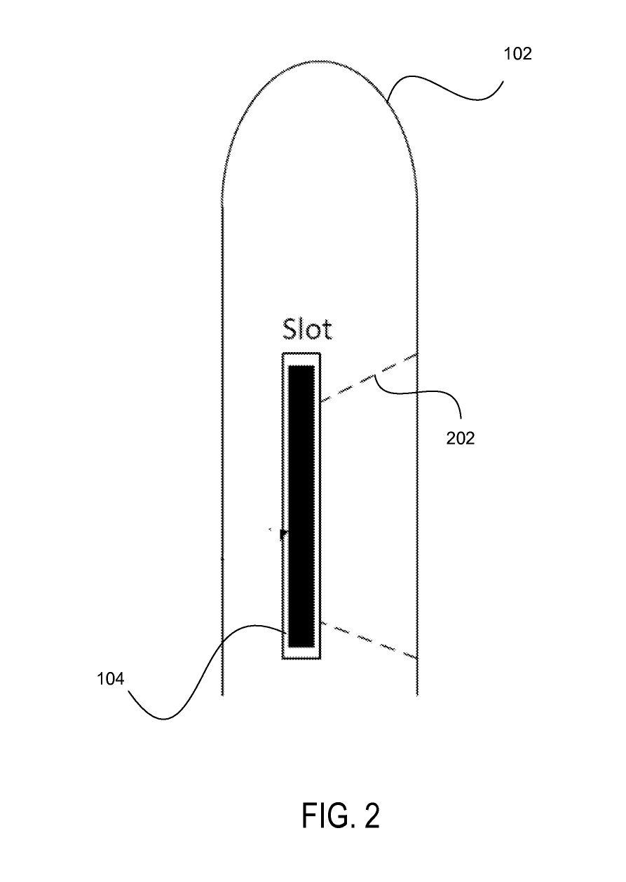

FIG. 2 illustrates a side view of the example mobile multifunction device with an opening for the disposable sensor card 106, according to one embodiment of the invention. In one implementation, the dashed lines (202) show an opening in the back, providing the disposable sensor card 106 direct access to the outside environment. For chemical sensors, where liquid may be needed to be applied to the disposable sensors, an opening in the rear of the mobile multifunction device may be provided to allow for applying of the analyte. This has the advantage of allowing discreet application in a social situation. For example, at a party the user of the mobile multifunction device 102 can test for gamma-Hydroxybutyric acid, a “drug facilitated sexual assault” drug in their drinks. In another implementation, one of the side walls of the opening 104 may be perforated to allow access to the outside environment.

The placement for a disposable sensor card 106 shown in FIG. 1 and FIG. 2 are example placements. Placing the disposable sensor card in an opening or slot in the mobile multifunctional device may allow the disposable sensor card to continuously monitor the environmental stimuli while the user may be using the mobile multifunctional device for other purposes, such as making/receiving calls, browsing the internet, etc. The interface associated with detecting the change in the disposable sensor card 106 may alert the user through a user interface (not shown) once a stimulus of interest is detected by the disposable sensor card. The user interface may alert the user by providing the user with a notification on the display of the mobile multifunctional device, providing the user with haptic feedback, an auditory signal or any other suitable means for notifying the user.

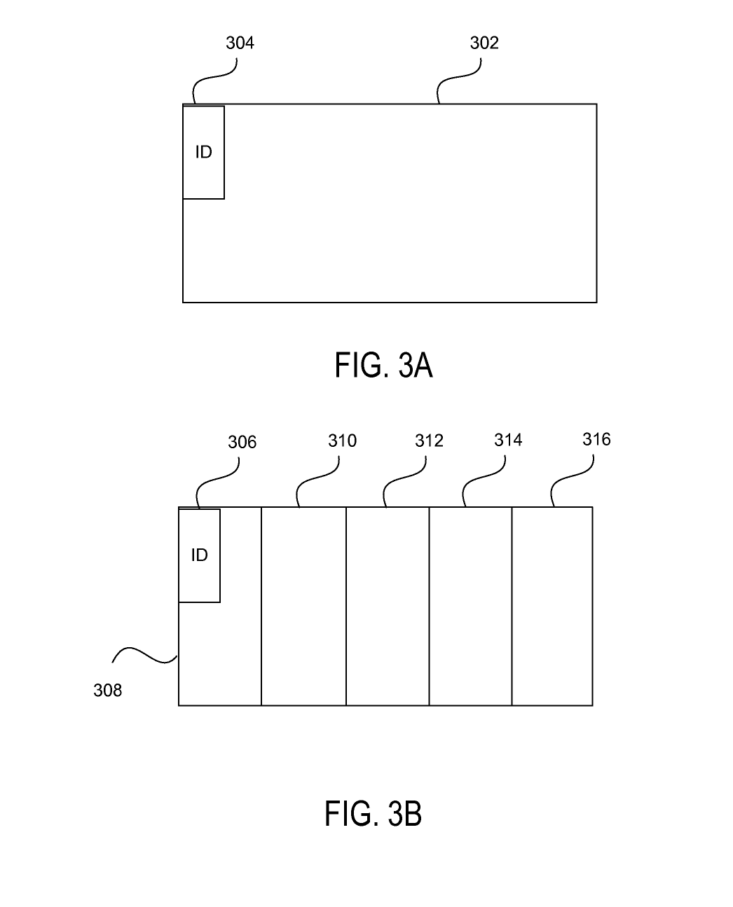

FIG. 3A illustrates an example disposable sensor card 302 according to one embodiment of the invention. In one embodiment, the disposable sensor card 302 may include a single disposable sensor material. The disposable sensor card 302 may have a function ID 304 associated with it. The function ID 304 may indicate the sensing capability of the disposable sensor card 302. In one implementation, the mobile multifunction device 102 may access the function ID 304 associated with the disposable sensor card 302 to determine the sensing functionality of the disposable sensor card 302 and react to stimulus/analytes accordingly. The mobile multifunction device 102 may read the function ID 304 and based on the reading of the function ID 304 determine that the disposable sensor card 302 is configured to detect a specific environmental stimulus and experience a non-transient change based on that stimulus. The mobile multifunction device 102 monitors the disposable sensor card 302 for a non-transient change, such as a change in physical form, in a pre-specified manner based on the function ID 304 associated with the disposable sensor card 302. When the disposable sensor on the disposable sensor card 304 changes physical form (e.g., color) the mobile multifunction device may provide an alert or indication to the user of the device of the detection of the presence of environmental stimulus. Once the disposable sensor in the disposable sensor card 302 is depleted or used, the user may change or replace the disposable sensor card 302. The disposable sensor card 302 may be considered used once the disposable sensors on the disposable sensor card has changed in a non-transient manner and can no longer detect the intended environmental stimuli.

In one implementation, the function ID 304 may be implemented using bumps and depressions on the disposable sensor card 302. In another implementation, the function ID 304 may be stored in a memory on the disposable sensor card 302.

FIG. 3B illustrates another example disposable sensor card 308 according to another embodiment of the invention. As shown in FIG. 3B, a disposable sensor card 308 may include multiple disposable sensors (310, 312, 314 and 316) having different sensing materials. It may be advantageous to have multiple disposable sensors on a single disposable sensor card 308. For example, for a pool water test, both the bromine and chlorine levels may need to be tested simultaneously to determine the quality of the water. Similarly, for an air quality test it may be desirable to test the air for different impurities using multiple disposable sensors at the same time. The mobile multifunction device may determine that the disposable sensor card 308 is comprised of multiple disposable sensors based on the reading of the function ID 306.

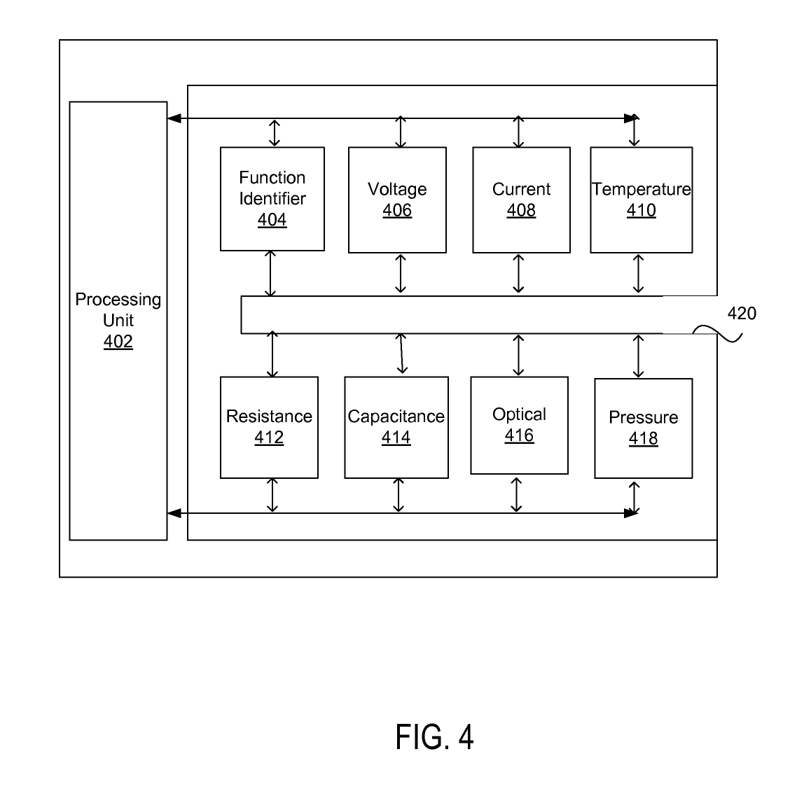

FIG. 4 depicts a block diagram, showing exemplary components and/or modules for performing methods provided by embodiments of the invention. Mobile multifunction device 102 discussed in FIG. 1 and FIG. 7, may represent some of the components of the mobile multifunction device 102 used for performing the embodiments of the invention described in FIG. 4. The components and modules discussed in FIG. 4 may be implemented in hardware, software, firmware or any combination thereof.

FIG. 4 illustrates an exemplary interface associated with receiving analog information from an opening/slot of the mobile multifunction device according to one embodiment of the invention. FIG. 4 describes an implementation of the interface for receiving analog information from a disposable sensor card described in FIG. 3A or FIG. 3B and converting the information to digital information for further processing by the processing unit 402. Conversion of analog to digital may be based on the ability to measure a voltage, a current, a resistance, a capacitance, the spectral reflection or absorption of a material, and other techniques.

FIG. 4 depicts functional blocks for measuring voltage 406, current 408, temperature 410, resistance 412, capacitance 414, optical spectral reflection 416 and pressure 418 from the disposable sensor card inserted in the opening or slot of the mobile multifunction device 420. The voltage module 406 may measure voltage with any of a number of semiconductor circuits, for example an op-amp connected as a voltage follower and a sigma-delta analog to digital converter. The current module 408 may measure current in a similar fashion, but with the op-amp connected as a trans-impedance amplifier to convert current to voltage and then followed by an analog to digital converter. The temperature module 410 may measure temperature, such as that of an exothermal chemical reaction, can be measured by monitoring the forward current of a silicon diode. The resistance module 412 may measure resistance by forcing a fixed current though the disposable sensor and measuring the voltage drop across the two terminals of the disposable sensor. The capacitance module 414 may measure capacitance by first connecting the two terminals of the capacitor together, followed by connecting one terminal to ground and the other to a fixed current source. The voltage change with time is measured and the capacitance is determined from C=i/dV/dt. The pressure module 418 may measure pressure with a strain gauge, which measures the change in resistance. The strain gauges may be mounted on a deformable membrane that responds to pressure. Many other configurations are possible and would depend on the sensor types to be used. It may be advantageous to have the interface flexible enough to measure a wide range of physical effects associated with a multitude disposable sensors allowing for enhancement of capabilities of the mobile multifunction device by updating the software/firmware on the mobile multifunction device.

The function identifier module 404 detects a function identifier associated with the disposable sensor card inserted in the opening of the mobile multifunction device. In one implementation, the function identifier value associated with the disposable sensor card may be sent for further processing to the processing unit 402 to determine the sensing capabilities of the disposable sensor card. The processing unit may execute a software module or activate a portion of the executable instructions within a software module based on the function identifier. The processing unit 402 may be one or more processors 710 described in FIG. 7, and the software module may be stored in working memory 735 as an application 745 or as part of an application 745. In one implementation, based on the function identifier, the mobile multifunction device 102 may activate specific detection modules associated with the interface for measuring the non-transient change in the disposable sensing material.

For example, in a simplified example, the function identifier value may identify the disposable sensor card as an air quality disposable sensor card with a single disposable sensor that changes color to red when the air quality is dangerously polluted. The processing unit 402 may activate the optical detection module 416 to detect red color on the disposable sensor card 104 based on the function identifier. Upon changing of the disposable sensor material to red, the optical module 416 detects the color change and sends digital information conveying the non-transient change in the sensing material to the processing unit 402. The processing unit 402 may in response alert the user through a user interface that the air quality is dangerously polluted. The user may replace the sensor once the sensor is used. The user interface for the mobile multifunction device may also alert the user, once or periodically, to replace the sensor once the sensor is used. In another implementation, the mobile multifunction device 102 may provide an indication that the disposable sensor is used that may cause the disposable sensors to be automatically ordered. Since the disposable sensor cards are relatively small and light, the cards can be mailed at low cost facilitating the restocking of disposable sensor cards.

Even though, many of the examples discussed herein are associated with detecting the change of color in response to environmental stimuli, other disposable sensor types may also be used. For example, chemically sensitive gels that swell in the presence of a sensed substance could be measured by use of capacitance. Also, nano materials could have sensitized surfaces that would change conducting form in the presence of a particular analyte and this could be measured by resistance.

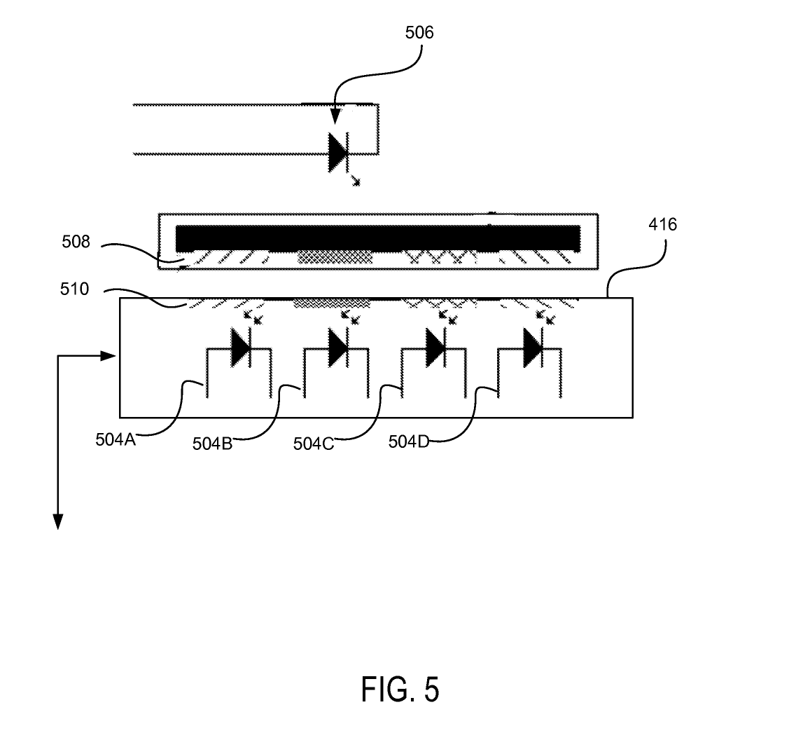

FIG. 5 illustrates an example interface for implementing the optical module 416 detecting one or more color changes at the mobile multifunction device according to an example embodiment of the mobile multifunction device. The interface coupled to the mobile multifunction device 102 may include filters 510 to allow color measurements appropriate for the particular chemistry of the disposable sensors. These filters could be selected to match the color response for various disposable sensors. In one implementation, there may be one filter for each color (spectral) range. In FIG. 5, four photo detectors (504A, 504B, 504C and 504D) are represented each with its own filter. In another implementation, the filters 508 may be implemented within the disposable sensor itself. Depending on the range of color change sensors desired there may be more or less number of photo detectors and filters. The photo detectors could be arranged linearly or in a 2D array or any other suitable manner. The filters, 508, may pass certain frequency bands of light and thus can be used to selectively observe the intensity in a particular band at the photo detectors. Implementing the filters in the disposable sensors may allow operation that is determined by the disposable sensor's construction, and avoid the cost of a spectrometer in the sensor interface of the mobile multifunction device. If the sensing was accomplished by operating the interface in reflection mode, then the light source and the light detector are on the same side of the sensing material, such that light reflecting off of the sensing material is collected at the light detector. FIG. 5 shows an internal light source 506. However, ambient light could also be used and thus save power.

FIG. 5 shows the system working in transmission, but the system may also be operable in reflection. For transmission, when the sensor interface is working to measure optical transmission, light passes from one side of the sensing material of the disposable sensor through to the other side and the difference in the intensity may be measured on the other side of the light source with respect to the disposable sensor. In some implementations, a reference beam, that does not go through the sensing material of the disposable sensor, is also sensed at the other side at the same time as the light beam passing through the sensing material of the disposable sensor. Comparisons between the reference beam and the light beam that passes through the sensing material of the disposable sensors allows for compensating for degradations or changes in the light source over time.

A wide variety of disposable sensors react by changing color in response to exposure to environmental stimuli. A few non-limiting examples include Structured Gel, paper incorporated with polydiactylenes, ground arsenic detector, food spoilage detector, and glucose detector.

Structured gel expands and contracts in one dimension resulting in color change. Structured gel responds to external stimuli such as PH and salt concentration, pressure, humidity and temperature.

Paper incorporated with polydiactylenes (PDAs) can also display different colors after exposure to different metal ions. Polymerization takes place and molecules are reordered in response to ultraviolet irradiation. The binding of the different metallic ions results in change in color.

Groundwater arsenic detector can be detected using a disposable sensor. In the presence of arsenic, aptamers are exhausted due to the formation of an As(III)-aptamer complex. Aptamers are molecules that bind to a specific target molecule. Aptamers and surfactants could assemble to form a super-molecule. Surfactants are compounds that lower the surface tension of a liquid, the interfacial tension between two liquids, or that between a liquid and a solid. These super-molecules may cause the aggregation of the gold nanoparticles. This results in a color change.

Food spoilage and ripening can also be detected using dyes printed on paper that react to volatiles as a result of spoilage in the food. The dyes change colors due to exposure.

In a glucose detection sensor, the phenylboronic acid binds to d-glucose in the presence of glucose and forms a negatively charged boronate complex. The additional negative charge swells the film causing it to reflect light in the wavelength of orange.

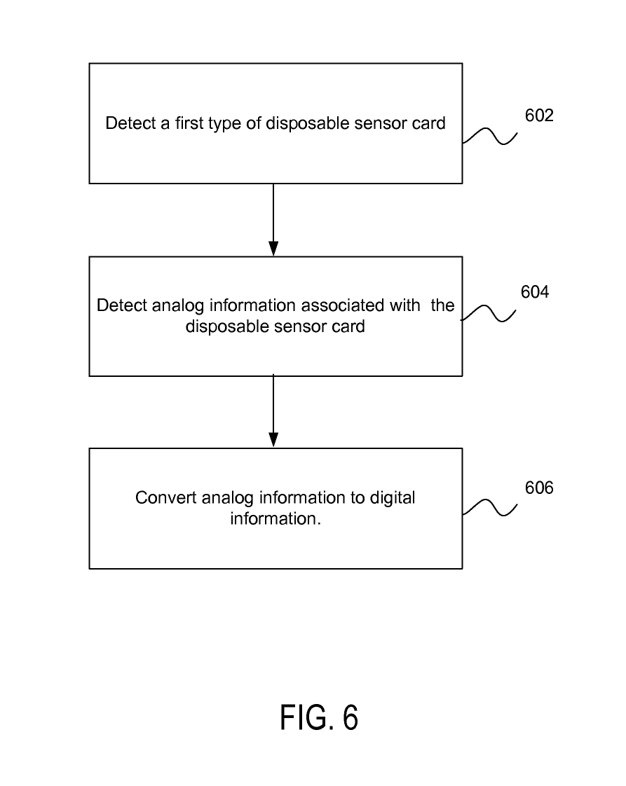

FIG. 6 is a flow diagram illustrating a method for performing embodiments of the invention according to one or more illustrative aspects of the disclosure. According to one or more aspects, any and/or all of the methods and/or method steps described herein may be implemented by and/or in a mobile multifunction device 100, such as the mobile multifunction device 100 and/or the device described in greater detail in FIG. 7, for instance. In one embodiment, one or more of the method steps described below with respect to FIG. 6 are implemented by a processor of the mobile multifunction device 700, such as the processor 710 or another processor. Modules and components discussed in FIG. 4, may also be implemented as components of the mobile multifunction device 700 and may be used in performing embodiments of the invention as discussed in FIG. 6. Additionally or alternatively, any and/or all of the methods and/or method steps described herein may be implemented in computer-readable instructions, such as computer-readable instructions stored on a computer-readable medium such as the memory 735, storage 725 or another computer readable medium.

At step 602, components of the mobile multifunction device may detect a first type of disposable sensor card at an interface coupled to the mobile multifunction device. The disposable sensor card is detected when mounted inside an opening/slot in the mobile multifunction device. The first type of disposable sensor card may be determined by detecting a first identifier associated with the first disposable sensor card. In one implementation, the function identifier module 404 detects the first identifier associated with the disposable sensor card using the processing unit 402.

In one implementation, the disposable sensor card comprises a single disposable sensor. In other implementations, the disposable sensor card includes multiple disposable sensors. The multiple disposable sensors in the disposable sensor card may include different sensing capabilities. It may be advantageous to have multiple sensors in the disposable sensor card to detect more than one stimuli and provide the user with a more comprehensive understanding of the environment. For example, for a pool water test, it would be advantageous to test for bromine and chlorine using different sensing materials. The disposable sensor may include, but is not limited to, one or more of a pressure sensor, a humidity sensor, a temperature sensor, a radiation sensor, a light sensor, or a chemical sensor.

The mobile multifunction device provides a flexible interface for disposable sensor cards and first disposable sensor may be easily removable and replaceable. In one embodiment, components of the mobile multifunction device may detect a second type of disposable sensor card when the first type of disposable sensor card is replaced with another disposable sensor card. The first type of disposable sensor card may have different sensing characteristics then the second type of disposable sensor card. It may be advantageous to support disposable sensor cards with differing sensing capabilities using the same opening and interface. For example, a user may want to test the air using a first disposable sensor and use the second disposable sensor as an alcohol breathalyzer. This allows the mobile multifunction device to support varying usage models by invoking or downloading different software application modules for different sensing applications.

For some applications, the disposable sensor card may be depleted after one use. The non-transient change in the form of at least a portion of the disposable sensor card from one form to another may indicate depletion of the disposable sensor card. In some implementations, the first disposable sensor card does not have a digital processor or an analog to digital convertor on the first disposable sensor card. It may be advantageous to simplify the design of the disposable sensor card, by excluding expensive components such as processing units, analog to digital converters and power supplies to reduce the cost associated with the disposable sensor cards.

At step 604, analog information associated with the disposable sensor card is detected. In one implementation, detecting analog information associated with the disposable sensor card may include detecting a non-transient change in at least a portion of the disposable sensors on the disposable sensor card, wherein the disposable sensors experiences non-transient changes in response to exposure to one or more stimuli from an environment of the disposable sensor card. In one embodiment, the analog and digital components residing on the mobile multifunction device measure the non-transient changes associated with the disposable sensor cards. In some aspects, detecting a non-transient change in at least a portion of the disposable sensor may include detecting a change in color, shape, chemical composition or electrical characteristics of one or more disposable sensors on the disposable sensor card.

At step 606, the analog information is converted to digital information. In one implementation, converting analog information to digital information may include determining one or more stimuli from the environment based on the non-transient change in at least a portion of the first disposable sensor card and the first type. Components of the mobile multifunction device, such as the analog to digital converter, may convert the analog information detected in step 604 to digital information. For example, in one implementation determining a non-transient change in the form of the first disposable sensor card may include detecting a color change associated with the first disposable sensor and converting color change information to digital information for further processing by the mobile multifunction device.

It should be appreciated that the specific steps illustrated in FIG. 6 provide a particular method of switching between modes of operation, according to an embodiment of the present invention. Other sequences of steps may also be performed accordingly in alternative embodiments. For example, alternative embodiments of the present invention may perform the steps outlined above in a different order. Furthermore, additional steps or variations to the steps may be added or removed depending on the particular applications. One of ordinary skill in the art would recognize and appreciate many variations, modifications, and alternatives of the process.

FIG. 7 illustrates an exemplary computing device incorporating parts of the device employed in practicing embodiments of the invention. A computing device as illustrated in FIG. 7 may be incorporated as part of any computerized system, herein. For example, computing device can represent some of the components of a mobile multifunction device 102. A mobile multifunction device 102 may be any computing system 700 with one or more input sensory unit or input devices 715 such as sensors 750 and one or more input/output devices such as a display unit or a touch screen. Examples of a computing device 700 include, but are not limited to, video game consoles, tablets, smart phones, laptops, netbooks, or other portable devices. In one embodiment, FIG. 7 describes one or more components of the mobile multifunction device 102 discussed in FIG. 1 and components and modules described in FIG. 4. FIG. 7 provides a schematic illustration of one embodiment of a computing device 700 that can perform the methods provided by various other embodiments, as described herein, and/or can function as the host computing device, a remote kiosk/terminal, a point-of-sale device, a mobile multifunction device, a set-top box and/or a computing device. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computing device 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a camera, sensors 750 (including photo detectors), a mouse, a keyboard and/or the like; and one or more output devices 720, which can include without limitation a display unit, a printer and/or the like. In one embodiment, the computing device 700 may also comprise a sensor interface as discussed in FIG. 4.

The computing device 700 may further include (and/or be in communication with) one or more non-transitory storage devices 725, which can comprise, without limitation, local and/or network accessible storage, and/or can include, without limitation, a disk drive, a drive array, an optical storage device, a solid-form storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computing device 700 might also include a communications subsystem 730, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), other computing devices, and/or any other devices described herein. In many embodiments, the computing device 700 will further comprise a non-transitory working memory 735, which can include a RAM or ROM device, as described above.

The computing device 700 can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. In one implementation, components or modules of FIG. 4 may be performed using such software elements. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computing device, such as computing device 700. In other embodiments, the storage medium might be separate from a computing device (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computing device 700 and/or might take the form of source and/or installable code, which, upon compilation and/or installation on the computing device 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices 700 such as network input/output devices may be employed.

Some embodiments may employ a computing device (such as the computing device 700) to perform methods in accordance with the disclosure. For example, some or all of the procedures of the described methods may be performed by the computing device 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computing device 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including, but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications). In an alternate embodiment, event-driven components and devices, such as cameras, may be used, where some of the processing may be performed in analog domain.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computing device 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A mobile multifunction device, comprising:
an opening in the mobile multifunction device for receiving a first disposable sensor card, wherein the first disposable sensor card comprises a first disposable sensor; and
an interface coupled to the opening configured to:
detect analog information associated with at least a portion of the first disposable sensor card; and
convert the analog information to digital information.

2. The mobile multifunction device of claim 1, wherein the first disposable sensor card is removable.

3. The mobile multifunction device of claim 1, wherein the mobile multifunction device is configured to receive the first disposable sensor card and a second disposable sensor card one at a time, wherein the first disposable sensor card has different sensing characteristics then the second disposable sensor card.

4. The mobile multifunction device of claim 1, wherein the first disposable sensor card comprises the first disposable sensor and a second disposable sensor, wherein the first disposable sensor and the second disposable sensor have different sensing characteristics.

5. The mobile multifunction device of claim 1, wherein
the interface is further configured to detect a first identifier associated with the first disposable sensor card; and
a processor coupled to the interface at the mobile multifunction device is configured to process the analog information based at least in part on the detected first identifier.

6. The mobile multifunction device of claim 1, wherein detecting analog information comprises detecting a non-transient change in at least a portion of the first disposable sensor card, wherein at least the portion of the first disposable sensor card changes in response to exposure to one or more stimuli from an environment of the first disposable sensor card.

7. The mobile multifunction device of claim 6, wherein the non-transient change comprises one or more of changing color, changing shape, changing chemical composition or changing electrical characteristics.

8. The mobile multifunction device of claim 1, wherein the first disposable sensor is one or more of a pressure sensor, a humidity sensor, a temperature sensor, a radiation sensor, a light sensor, or a chemical sensor.

9. The mobile multifunction device of claim 1, wherein converting the analog information to the digital information comprises detecting a color associated with the first disposable sensor and converting the color information to the digital information for further processing by a processor.

10. The mobile multifunction device of claim 9, further comprising sensing material of the first disposable sensor followed by an at least one optical filter for detecting a color associated with the first disposable sensor, in light path between a light source and a photo detector.

11. The mobile multifunction device of claim 1, wherein the first disposable sensor card is depleted after one use.

12. The mobile multifunction device of claim 1, wherein the first disposable sensor card does not have a digital processor or an analog to digital convertor on the first disposable sensor card.

13. A method comprising:
detecting, at a mobile multifunction device, a first type of a disposable sensor card at an interface coupled to the mobile multifunction device, wherein the disposable sensor card is placed inside an opening in the mobile multifunction device;
detecting, at the mobile multifunction device, analog information associated with the disposable sensor card; and
converting, at the mobile multifunction device, analog information to digital information.

14. The method of claim 13, wherein detecting analog information comprises detecting a non-transient change in at least a portion of the disposable sensor card, wherein the non-transient change in at least the portion of the disposable sensor card is in response to exposure to one or more stimuli from an environment of the disposable sensor card.

15. The method of claim 13, wherein converting analog information associated with at least a portion of the disposable sensor card comprises determining an environmental stimuli based on a non-transient change in at least a portion of the disposable sensor card and the first type.

16. The method of claim 13, wherein the disposable sensor card is removable.

17. The method of claim 13, further comprises detecting a second type of disposable sensor card when the first type of the disposable sensor card is replaced with another disposable sensor card, wherein the first type of the disposable sensor card has different sensing characteristics then the second type of disposable sensor card.

18. The method of claim 13, wherein the disposable sensor card comprises a first disposable sensor and a second disposable sensor, wherein the first disposable sensor and the second disposable sensor have different sensing characteristics.

19. The method of claim 13, wherein the first type of the disposable sensor card is determined at least in part by detecting a first identifier associated with the disposable sensor card.

20. The method of claim 13, wherein changing form comprises one or more of changing color, changing shape, changing chemical composition or changing electrical characteristics.

21. The method of claim 13, wherein the disposable sensor card comprises a disposable sensor and the disposable sensor is one or more of a pressure sensor, a humidity sensor, a temperature sensor, a radiation sensor, a light sensor, or a chemical sensor.

22. The method of claim 13, wherein detecting analog information comprises detecting a color change associated with at least a portion of the disposable sensor card and converting analog information to digital information comprises converting the color change information to the digital information for further processing.

23. The mobile multifunction device of claim 9, further comprising sensing material of the first disposable sensor followed by an at least one optical filter for detecting a color associated with the first disposable sensor, in light path between a light source and a photo detector.

24. The method of claim 13, wherein the disposable sensor card is depleted after one use.

25. The method of claim 13, wherein the disposable sensor card does not have a digital processor or an analog to digital convertor present on the disposable sensor card.

26. A non-transitory computer readable storage medium, wherein the non-transitory computer readable storage medium comprises instructions executable by a processor, the instructions comprising instructions to:
detect a first type of a disposable sensor card at an interface coupled to a mobile multifunction device, wherein the disposable sensor card is placed inside an opening in the mobile multifunction device;
detect analog information associated with the disposable sensor card; and
convert analog information to digital information.

27. An apparatus, comprising:
means for detecting, at a mobile multifunction device, a first type of a disposable sensor card at an interface coupled to the mobile multifunction device, wherein the disposable sensor card is placed inside an opening in the mobile multifunction device;
means for detecting, at the mobile multifunction device, analog information associated with the disposable sensor card; and
means for converting, at the mobile multifunction device, analog information to digital information.
